(19) United States
(12) Patent Application Publication
(10) Pub. No.: US 2026/0153393 A1
(43) Pub. Date: Jun. 4, 2026

(54) METHOD FOR ANALYZING POST-ASSEMBLY RESIDUAL STRESSES IN MICROWAVE ASSEMBLY

(71) Applicant: 38TH RESEARCH INSTITUTE, CHINA ELECTRONICS TECHNOLOGY GROUP CORPORATION, Hefei (CN)

(72) Inventors: Hongqi ZHANG, Hefei (CN); Wenjun SHENG, Hefei (CN)

(21) Appl. No.: 19/457,927

(22) Filed: Jan. 23, 2026

Related U.S. Application Data
(63) Continuation of application No. PCT/CN2023/128315, filed on Oct. 31, 2023.

(30) Foreign Application Priority Data
Sep. 11, 2023 (CN) 202311160213.6

(51) Int. Cl. G01L 5/00; G06F 30/23; G06F 111/10; G06F 119/08; G06F 119/14

(52) U.S. Cl. CPC G01L 5/0047; G06F 30/23; G06F 2111/10; G06F 2119/08; G06F 2119/14

(57) ABSTRACT

A method for analyzing post-assembly residual stresses in a microwave assembly, in which a three-dimensional model of the microwave assembly and a three-dimensional model of a tooling required for each high-temperature treatment are established; a finite element mesh model of the entire microwave assembly and a finite element mesh model of the tooling are established based on their respective three-dimensional models; performing simulation analysis on each high-temperature treatment process based on the finite element mesh model to obtain residual stress distribution; and superimposing the residual stress distributions of all high-temperature treatment processes to obtain a post-assembly residual stress distribution.

### CROSS-REFERENCE TO RELATED APPLICATIONS

This application is a continuation of International Patent Application No. PCT/CN2023/128315, filed on Oct. 31, 2023, which claims the benefit of priority from Chinese Patent Application No. 202311160213.6, filed on Sep. 11, 2023. The content of the aforementioned applications, including any intervening amendments thereto, is incorporated herein by reference in its entirety.

### TECHNICAL FIELD

This application relates to the field of stress analysis technology, and more particularly to a method for analyzing post-assembly residual stresses in a microwave assembly.

### BACKGROUND

Microwave assemblies serve as reception and transmission channels for microwave signals and are among the most critical modules of radar systems. The performance of the microwave assembly directly determines the technical specifications of the radar system as a whole. An assembly of the microwave assembly involves high-temperature processes and an assembly process that requires overall thermal treatment, and thus may generate significant residual stresses. Residual stresses generated during the assembly process of the microwave assembly is a critical factor that affects the overall performance of the microwave assembly. With the miniaturization, array integration, and comprehensive integration of the radar system, the microwave assembly is evolving towards high-density, three-dimensionalization, and integration. A superimposition of residual stresses during a manufacturing process with operational stresses can further deteriorate an operating state of the microwave assembly, and the impact of the residual stresses on the lifespan and performance of the microwave assembly becomes more pronounced.

The high-temperature processes of microwave assemblies generally require the assistance of tooling for applying pressure to a soldering/welding/brazing surface or optimizing structural heat transfer. Through extensive research and practice, the inventors have found that when the soldering/welding/brazing surface reaches a temperature window, the heat transfer processes of microwave assemblies and their corresponding tooling vary under different process conditions, and temperature responses in different regions with distinct structures are also different, resulting in an uneven temperature distribution. In addition to differences in thermal expansion coefficients of materials of the microwave assembly, variations in the structural temperature distribution will directly lead to large residual stresses after assembly.

For assembly processes of the microwave assembly that require overall thermal treatment and are prone to significant residual stresses, there is currently a lack of a method for systematically analyzing residual stresses generated after the assembly of microwave assembly. Considering the uneven temperature distribution in the microwave assembly, how to analyze the residual stresses after multi-step assembly processes remains a technical challenge.

### SUMMARY

In view of the deficiencies in the related art, the present disclosure provides a method for analyzing post-assembly residual stresses in a microwave assembly, which solves a problem of how to analyze residual stresses after assembly of the microwave assembly.

To achieve the above objective, the present disclosure is implemented through the following technical solutions.

This application provides a method for analyzing post-assembly residual stresses in a microwave assembly. The microwave assembly includes a housing, a low temperature co-fired ceramics (LTCC) substrate, a connector, partition ribs, a carrier module, a plurality of components, and a cover plate, the carrier module and the plurality of components are assembled on the LTCC substrate, the carrier module includes a carrier and a power chip assembled on the carrier, the LTCC substrate is assembled in the housing, the connector is assembled on the housing, and the partition ribs are assembled on the LTCC substrate for forming of microwave channels that are mutually isolated with one another. The method includes:
obtaining a three-dimensional model of the entire microwave assembly and a three-dimensional model of a tooling required for each high-temperature treatment process based on each high-temperature treatment process involved in an assembly process of the microwave assembly;
obtaining a finite element mesh model of the entire microwave assembly based on the three-dimensional model of the entire microwave assembly;
obtaining a finite element mesh model of the tooling required for each high-temperature treatment process based on the three-dimensional model of the tooling required for each high-temperature treatment process;
performing simulation analysis on each high-temperature treatment process based on the finite element mesh model to obtain a residual stress distribution of each high-temperature treatment process; and
superimposing the residual stress distribution of each high-temperature treatment process to obtain a post-assembly residual stress distribution.

In an embodiment, the assembly process of the microwave assembly includes:
soldering the power chip to the carrier using gold-tin solder via hot-plate soldering to obtain the carrier module;
bonding part of the plurality of components to the LTCC substrate via adhesive bonding;
soldering the carrier module, the rest of the plurality of components, and the partition ribs to the LTCC substrate using SAC305 solder via reflow soldering;
soldering the LTCC substrate and the connector to the housing using tin-lead solder via low-temperature vacuum brazing; and
welding the housing with the cover plate via laser welding.

In an embodiment, the step of performing the simulation analysis on each high-temperature treatment process based on the finite element mesh model to obtain the residual stress distribution of each high-temperature treatment process includes:
performing thermal simulation based on a thermal analysis model of each high-temperature treatment process, to obtain a temperature distribution when a temperature control curve decreases to a solder melting point; and
performing mechanical simulation based on a mechanical analysis model of each high-temperature treatment process and the temperature distribution, to obtain a residual stress distribution σ when the microwave assembly is cooled to room temperature.

In an embodiment, the step of performing the thermal simulation based on the thermal analysis model of each high-temperature treatment process, to obtain the temperature distribution when the temperature control curve decreases to the solder melting point includes:
performing transient thermal analysis using finite element analysis software based on the finite element mesh model corresponding to each high-temperature treatment process, to obtain a pre-calibration temperature distribution when the temperature control curve decreases to the solder melting point;
obtaining a calibration result of a key thermal parameter corresponding to each high-temperature treatment process based on the pre-calibration temperature distribution when the temperature control curve decreases to the solder melting point; and
performing transient thermal analysis again using the finite element analysis software based on the calibration result of the key thermal parameter, to obtain a post-calibration temperature distribution when the temperature control curve decreases to the solder melting point.

In an embodiment, soldering the power chip to the carrier via hot-plate soldering corresponds to a first high-temperature treatment process; and in the first high-temperature treatment process, the key thermal parameter is an interfacial thermal resistance R_imp between a hot plate and an assembly.

For the first high-temperature treatment process, the thermal simulation includes:
importing a finite element mesh model of the power chip and the carrier that are assembled via hot-plate soldering and a finite element mesh model of a corresponding tooling into a finite element analysis software Abaqus®; during software setup, setting the hot plate as a heat source, setting a temperature of the heat source as a hot-plate temperature control curve, and determining an empirical value of the interfacial thermal resistance between the hot plate and the assembly;
performing transient thermal analysis using the finite element analysis software, to obtain a temperature distribution of the microwave assembly when the hot-plate temperature control curve decreases to a gold-tin solder melting point of 280° C.;
calibrating the interfacial thermal resistance between the hot plate and the assembly to obtain a corrected empirical value R′ᵢₘₚ of the interfacial thermal resistance between the hot plate and the assembly; and
performing transient thermal analysis again based on the corrected empirical value R′ᵢₘₚ of the interfacial thermal resistance between the hot plate and the assembly, to obtain a corrected temperature distribution of the microwave assembly when the hot-plate temperature control curve decreases to the solder melting point.

In an embodiment, calibrating the interfacial thermal resistance between the hot plate and the assembly satisfies the following expressions:

$$Min f ( α ) = \sum {( α {T}_{K} - {t}_{K} )}^{2} ; and {R}_{imp}^{′} = α * {R}_{imp}$$

where α represents a correction coefficient when f(α) is minimum, and α is obtained by calculation;
T_{K} represents a simulated temperature value at a K-th detection point, and T_{K} is obtained by simulation software;
t_{K} represents a detected temperature value at the K-th detection point, and t_{K} is obtained by a temperature sensor placed on a surface of a test piece or at a test hole within the test piece;
Rᵢₘₚ represents the empirical value of the interfacial thermal resistance between the hot plate and the assembly; and
R′ᵢₘₚ represents the corrected empirical value of the interfacial thermal resistance between the hot plate and the assembly.

In an embodiment, soldering the carrier module, the rest of the plurality of components, and the partition ribs to the LTCC substrate via reflow soldering corresponds to a second high-temperature treatment process; and in the second high-temperature treatment process, the key thermal parameter is a convective heat transfer coefficient h.

For the second high-temperature treatment process, the thermal simulation includes:
importing finite element mesh models corresponding to the carrier module, the rest of the plurality of components, the partition ribs, the LTCC substrate, and a corresponding tooling into a finite element analysis software Abaqus®; setting surfaces of the assembly and the tooling in contact with hot air as convective heat transfer surfaces, determining an empirical value of the convective heat transfer coefficient, and setting a hot-air temperature as a furnace temperature control curve;
performing transient thermal analysis using the finite element analysis software, to obtain a temperature distribution of the microwave assembly when the furnace temperature control curve decreases to a SAC305 solder melting point of 218° C.;
calibrating the convective heat transfer coefficient by placing five temperature sensors on a surface of the assembly or a surface of the tooling, to obtain a corrected convective heat transfer coefficient h′; and
performing transient thermal analysis again based on the corrected convective heat transfer coefficient h′, to obtain a corrected temperature distribution of the microwave assembly when the furnace temperature control curve decreases to the solder melting point.

In an embodiment, calibrating the convective heat transfer coefficient satisfies the following expressions:

Min f(α)=Σ(αT_{K}−t_{K})²; and h′=α*h
where α represents a correction coefficient when f(α) is minimum, and α is obtained by calculation;
T_{K} represents a simulated temperature value at a K-th detection point, and T_{K} is obtained by simulation software;
t_{K} represents a detected temperature value at the K-th detection point, and t_{K} is obtained by a temperature sensor;
h represents an empirical value of the convective heat transfer coefficient; and
h′ represents the corrected convective heat transfer coefficient.

In an embodiment, soldering the LTCC substrate and the connector to the housing via low-temperature vacuum brazing corresponds to a third high-temperature treatment process; and in the third high-temperature treatment process, the key thermal parameter is a surface emissivity.

For the third high-temperature treatment process, the thermal simulation includes:
importing an .inp file of a corresponding finite element mesh model into Abaqus®, setting a heating wire in a furnace as a radiation heat source, determining an empirical value of a surface emissivity of the assembly and the tooling, and setting a temperature of the radiation heat source as a furnace temperature control curve;
performing transient thermal analysis using the finite element analysis software, to obtain a temperature distribution of the microwave assembly when the furnace temperature control curve decreases to the solder melting point;
calibrating the surface emissivity ε of the assembly and the tooling by placing three temperature sensors on a surface of the assembly to obtain a corrected surface emissivity ε′; and
performing transient thermal analysis again based on the corrected surface emissivity ε′, to obtain a corrected temperature distribution of the microwave assembly when the furnace temperature control curve decreases to the solder melting point.

In an embodiment, calibrating the surface emissivity ε of the assembly and the tooling satisfies the following expressions:

$$Min f ( α ) = \sum {( α {T}_{K} - {t}_{K} )}^{2} ; and {ε}^{′} = α * ε$$

where α represents a correction coefficient when f(α) is minimum, and α is obtained by calculation;
T_{K} represents a simulated temperature value at a K-th detection point, and T_{K} is obtained by simulation software;
t_{K} represents a detected temperature value at the K-th detection point, and t_{K} is obtained by a temperature sensor;
ε represents an empirical value of the surface emissivity; and
ε′ represents the corrected surface emissivity.

Compared with the related art, the method provided herein has the following beneficial effects.

The technical solution of the present disclosure can be used for assembly processes requiring overall thermal treatment that generate significant residual stresses. Finite element modeling is performed on heat transfer processes of the assembly process, and key thermal parameters are tested and calibrated, so as to obtain the temperature distribution of the microwave assembly after each assembly process step. Accordingly, the residual stress distribution of the microwave assembly after each assembly process step is obtained, and eventually the residual stress distribution of the microwave assembly after assembly is obtained, thereby solving the technical problem of how to analyze residual stresses after assembly.

### BRIEF DESCRIPTION OF THE DRAWINGS

In order to illustrate technical solutions in embodiments of the present disclosure or the related art more clearly, the accompanying drawings needed in the description of the embodiments or related art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a schematic structural view of a microwave assembly provided in embodiments of the present disclosure.

FIG. 2 is a schematic view of tooling required for a high-temperature treatment process provided in embodiments of the present disclosure.

FIG. 3 is a flow chart of a method for analyzing post-assembly residual stresses in a microwave assembly provided in embodiments of the present disclosure.

In the figures: 1—housing, 2—LTCC substrate, 3—connector, 4—partition rib, 5—carrier module, 51—carrier, 52—power chip, 6—component, 7—cover plate, and 8—pressing block tooling.

### DETAILED DESCRIPTION OF EMBODIMENTS

In order to make the objectives, technical solutions, and advantages of the embodiments of the present disclosure more clearly understood, the technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure.

The embodiments of the present disclosure provide a method for analyzing post-assembly residual stresses in a microwave assembly, thereby solving a problem of how to analyze residual stresses of the microwave assembly after assembly.

In order to better understand the above technical solutions, the above technical solutions will be described in detail below in conjunction with the accompanying drawings and specific embodiments.

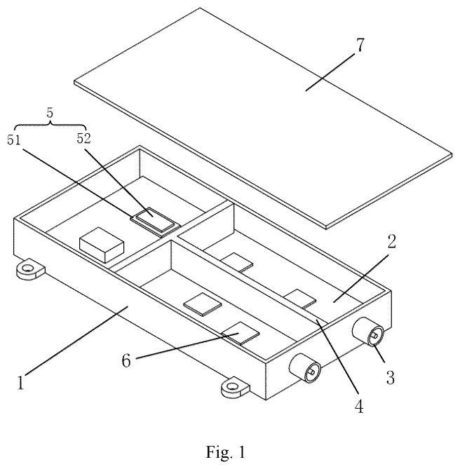

As shown in FIG. 1, the microwave assembly includes a housing 1, a low-temperature co-fired ceramic (LTCC) substrate 2, a connector 3, partition ribs 4, a carrier module 5, multiple components 6, and a cover plate 7. The carrier module 5 and the components 6 are assembled on the LTCC substrate 2. The carrier module 5 includes a carrier 51 and a power chip 52 assembled on the carrier 51. The LTCC substrate 2 is assembled in the housing 1, and the connector 3 is assembled on the housing 1. The partition ribs 4 are assembled on the LTCC substrate 2 for forming of microwave channels that are mutually isolated with one another.

The assembly process of the microwave assembly includes the following steps:
1) soldering the power chip 52 to the carrier 51 via hot-plate soldering (solder: gold-tin) to obtain the carrier module 5;
2) bonding part of the multiple components 6 to the LTCC substrate 2 via adhesive bonding;
3) soldering the carrier module 5, the rest of the multiple components 6, and the partition ribs 4 to the LTCC substrate 2 via reflow soldering (solder: SAC305);
4) soldering the LTCC substrate 2 and the connector 3 to the housing 1 via low-temperature vacuum brazing (solder: tin-lead);
5) welding the housing 1 with the cover plate 7 via laser welding.

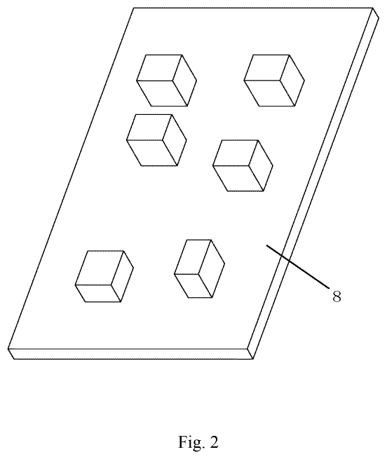

Thus, the high-temperature treatment processes involved in the assembly process of the microwave assembly include hot-plate soldering, reflow soldering, vacuum reflow soldering, vacuum vapor phase soldering, and low-temperature vacuum brazing, among others. Such processes generally require the assistance of tooling. Taking reflow soldering as an example, a pressing block tooling 8 as shown in FIG. 2 may be used to apply pressure to a soldering surface or to optimize structural heat transfer. Through extensive research and practice, the inventors have found that when the soldering surface reaches a temperature window, the heat transfer processes of microwave assemblies and their corresponding tooling vary under different process conditions, and temperature responses in different regions with distinct structures are also different, resulting in an uneven temperature distribution. In addition to differences in thermal expansion coefficients of materials of the microwave assembly, variations in the structural temperature distribution will directly lead to large residual stresses after assembly. Therefore, it is necessary to analyze the residual stresses of the microwave assembly after a multi-step assembly process while considering the non-uniform temperature distribution of the microwave assembly.

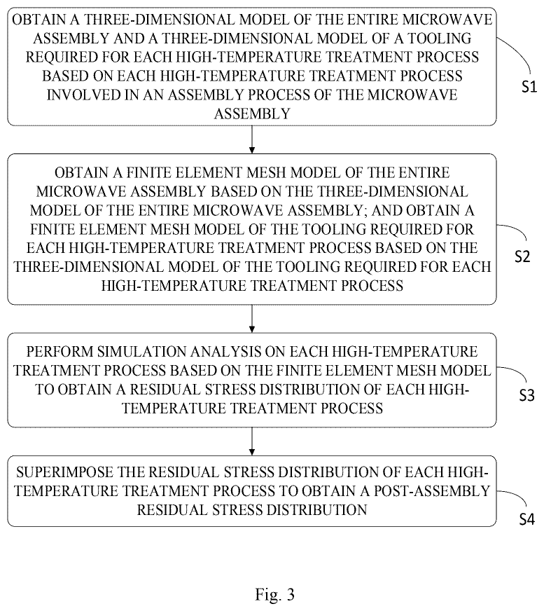

For the assembly process requiring overall thermal treatment that generates significant residual stresses, the inventors provide the following operations. Finite element modeling is performed on heat transfer processes of the assembly process, and key thermal parameters are tested and calibrated, so as to obtain the temperature distribution of the microwave assembly after each assembly process step. Accordingly, the residual stress distribution of the microwave assembly after each assembly process step is obtained, and eventually the residual stress distribution of the microwave assembly after assembly is obtained, thereby solving the technical problem of how to analyze residual stresses after assembly. Referring to FIG. 3, the method for analyzing post-assembly residual stresses in the microwave assembly includes operations carried out in S1˜S4.

At S1, a three-dimensional model of the entire microwave assembly and a three-dimensional model of a tooling required for each high-temperature treatment process are obtained based on each high-temperature treatment process involved in an assembly process of the microwave assembly.

Specifically, as shown in FIG. 1, the three-dimensional model of the entire microwave assembly includes various independent components of the microwave assembly, and the three-dimensional model of the tooling required for each high-temperature treatment process (hot-plate soldering, reflow soldering, low-temperature vacuum brazing, etc.) includes tooling components used in each process. The three-dimensional model may be in the STP format.

At S2, a finite element mesh model of the entire microwave assembly is obtained based on the three-dimensional model of the entire microwave assembly; and a finite element mesh model of the tooling required for each high-temperature treatment process is obtained based on the three-dimensional model of the tooling required for each high-temperature treatment process.

Specifically, operations at S2 further include the following. Material properties and assigned meshes corresponding to each finite element mesh model are acquired. A finite element mesh model required for each process is extracted from the finite element mesh model, for subsequent analysis steps. The finite element mesh model may be in INP format.

At S3, simulation analysis is performed on each high-temperature treatment process based on the finite element mesh model to obtain a residual stress distribution of each high-temperature treatment process. Specifically, operations carried out at S3 include operations carried out in S3.1˜S3.2.

At S3.1, thermal simulation is performed based on a thermal analysis model of each high-temperature treatment process, to obtain a temperature distribution when a temperature control curve decreases to a solder melting point. Specifically, operations carried out at S3.1 include operations carried out at S3.1.1˜S3.1.3.

At S3.1.1, transient thermal analysis is performed using finite element analysis software based on the finite element mesh model corresponding to each high-temperature treatment process, to obtain a pre-calibration temperature distribution (which is a simulation value) when the temperature control curve decreases to the solder melting point.

At S3.1.2, based on the pre-calibration temperature distribution when the temperature control curve decreases to the solder melting point, a calibration result of a key thermal parameter corresponding to each high-temperature treatment process is obtained.

At S3.1.3, transient thermal analysis is performed again using the finite element analysis software based on the calibration result of the key thermal parameter, to obtain a post-calibration temperature distribution (which is a simulation value) when the temperature control curve decreases to the solder melting point.

Specifically, the thermal simulation steps of different high-temperature treatment processes are different. The following provides specific descriptions by taking hot-plate soldering, reflow soldering, and low-temperature vacuum brazing involved in the assembly of the microwave assembly as examples.
(1) A first high-temperature treatment process is assembling the power chip 52 and the carrier 51 via hot-plate soldering, and the key thermal parameter is an interfacial thermal resistance Rᵢₘₚ between a hot plate and an assembly. The first high-temperature treatment process includes the following steps:
   a finite element mesh model of the power chip 52 and the carrier 51 that are assembled via hot-plate soldering and a finite element mesh model of a corresponding tooling are imported into a finite element analysis software Abaqus®; during software setup, the hot plate is set as a heat source, a temperature of the heat source is set as a hot-plate temperature control curve, and an empirical value of the interfacial thermal resistance between the hot plate and the assembly is 0.5E-4-5E-4 K·m²/W, with 2E-4 K·m²/W selected; and transient thermal analysis is performed using the finite element analysis software, to obtain a temperature distribution of the microwave assembly when the hot-plate temperature control curve decreases to a gold-tin solder melting point of 280° C. It should be noted that, in the first high-temperature treatment process, the assembly includes the power chip 52 and the carrier 51.

Calibrating the interfacial thermal resistance between the hot plate and the assembly satisfies the following expressions:

$$Min f ( α ) = \sum {( α {T}_{K} - {t}_{K} )}^{2} ; and {R}_{imp}^{′} = α * {R}_{imp}$$

where α represents a correction coefficient when f(α) is minimum, and α is obtained by calculation;
T_{K} represents a simulated temperature value at a K-th detection point, and T_{K} is obtained by simulation software;
t_{K} represents a detected temperature value at the K-th detection point, and t_{K} is obtained by a temperature sensor placed on a surface of a test piece or at a test hole within the test piece;
Rᵢₘₚ represents the empirical value of the interfacial thermal resistance between the hot plate and the assembly; and
R′ᵢₘₚ represents the corrected empirical value of the interfacial thermal resistance between the hot plate and the assembly.

Transient thermal analysis is performed again based on the corrected empirical value R′ᵢₘₚ of the interfacial thermal resistance between the hot plate and the assembly, to obtain a corrected temperature distribution of the microwave assembly when the hot-plate temperature control curve decreases to the solder melting point.
(2) A second high-temperature treatment process is soldering the carrier module 5, the rest of the multiple components 6, and the partition ribs 4 to the LTCC substrate 2 via reflow soldering corresponds to; and the key thermal parameter is a convective heat transfer coefficient h, and the second high-temperature treatment process includes the following steps:
   finite element mesh models corresponding to the carrier module 5, the rest of the multiple components 6, the partition ribs 4, the LTCC substrate 2, and a corresponding tooling are imported into a finite element analysis software Abaqus®; surfaces of the assembly and the tooling in contact with hot air serve as convective heat transfer surfaces, an empirical value of the convective heat transfer coefficient h is 20˜300 W/(m²·K), with 100 W/(m²·K) selected, and a hot-air temperature is set as a furnace temperature control curve; and transient thermal analysis is performed using the finite element analysis software, to obtain a temperature distribution of the microwave assembly when the furnace temperature control curve decreases to a SAC305 solder melting point of 218° C. It should be noted that, in the second high-temperature treatment process, the assembly includes the carrier module 5, the rest of the multiple components 6, the partition ribs 4, and the LTCC substrate 2.

Calibrating the interfacial thermal resistance includes placing five temperature sensors on a surface of the assembly or a surface of the tooling and satisfies the following expressions:

$$Min f ( α ) = \sum {( α {T}_{K} - {t}_{K} )}^{2} ; and {h}^{′} = α * h$$

where α represents a correction coefficient when f(α) is minimum, and α is obtained by calculation;
T_{K} represents a simulated temperature value at a K-th detection point, and T_{K} is obtained by simulation software;
t_{K} represents a detected temperature value at the K-th detection point, and t_{K} is obtained by a temperature sensor;
h represents an empirical value of the convective heat transfer coefficient; and
h′ represents the corrected convective heat transfer coefficient.

Transient thermal analysis is performed again based on the corrected convective heat transfer coefficient h′, to obtain a corrected temperature distribution of the microwave assembly when the furnace temperature control curve decreases to the solder melting point.

It should be noted that steps of vacuum reflow soldering or vacuum vapor phase soldering are similar to those of the reflow soldering.
(3) A third high-temperature treatment process is soldering the LTCC substrate and the connector to the housing via low-temperature vacuum brazing, the key thermal parameter is a surface emissivity ε of the assembly and the tooling, and the third high-temperature treatment process includes the following steps:
   an .inp file of a corresponding finite element mesh model is imported into Abaqus®, where a heating wire in a furnace serves as a radiation heat source, an empirical value of a surface emissivity ε of the assembly and the tooling is 0.5 W/(m·K), and a temperature of the radiation heat source is set as a furnace temperature control curve; and transient thermal analysis is performed using the finite element analysis software, to obtain a temperature distribution of the microwave assembly when the furnace temperature control curve decreases to the solder melting point. It should be noted that, in the third high-temperature treatment process, the assembly includes the LTCC substrate 2, the connector 3, and the housing 1.

Calibrating the surface emissivity ε of the assembly and the tooling includes placing three temperature sensors on a surface of the assembly and satisfies the following expressions:

$$Min f ( α ) = \sum {( α {T}_{K} - {t}_{K} )}^{2} ; and {ε}^{′} = α * ε$$

where α represents a correction coefficient when f(α) is minimum, and α is obtained by calculation;
T_{K} represents a simulated temperature value at a K-th detection point, and T_{K} is obtained by simulation software;
t_{K} represents a detected temperature value at the K-th detection point, and t_{K} is obtained by a temperature sensor;
ε represents an empirical value of the surface emissivity; and
ε′ represents the corrected surface emissivity.

Transient thermal analysis is performed again based on the corrected surface emissivity ε′, to obtain a corrected temperature distribution of the microwave assembly when the furnace temperature control curve decreases to the solder melting point.

At S3.2, mechanical simulation is performed based on a mechanical analysis model of each high-temperature treatment process and the temperature distribution, to obtain a residual stress distribution σ when the microwave assembly is cooled to room temperature.

Specifically, the mechanical analysis model corresponding to the high-temperature treatment process is established, mechanical constraint boundaries are added to the finite element mesh model of the high-temperature treatment process, i.e., constraining the degree of freedom in a vertical direction of a bottom surface of the assembly, and the obtained temperature distribution is added to the model, to perform mechanical simulation to obtain the residual stress distribution σ when the microwave assembly is cooled to room temperature, where a tensile stress is positive and a compressive stress is negative.

At S4, the residual stress distribution of each high-temperature treatment process is superimposed o obtain a post-assembly residual stress distribution.

In summary, compared with the related art, the present disclosure has the following beneficial effects.
1. For the assembly processes of the microwave assembly that require overall heat treatment and generate significant residual stresses during assembly of the microwave assembly, the present disclosure performs finite element modeling on heat transfer processes of the assembly process and tests and calibrates key thermal parameters, so as to obtain the temperature distribution of the microwave assembly after each assembly process step. Accordingly, the residual stress distribution of the microwave assembly after each assembly process step is obtained, and eventually the residual stress distribution of the microwave assembly after assembly is obtained, thereby solving the technical problem of how to analyze residual stresses after assembly.
2. The present disclosure considers differences in heat transfer mechanisms of different assembly processes, and adopts different thermal models for different assembly processes, which can truly reflect the temperature distribution of the microwave assembly during the process.
3. The present disclosure adopts a method combining simulation and testing to calibrate key parameters of the heat transfer model, thereby improving the accuracy of the calculation results.
4. The present disclosure comprehensively considers the influence of tooling on the temperature distribution of the microwave assembly, and more accurately models the assembly process.
5. Based on the temperature distribution law of the microwave assembly, the present disclosure realizes correlation analysis of residual stresses of the microwave assembly in related process steps through a thermo-mechanical coupling method.

It should be noted that, through the description of the above embodiments, those of ordinary skill in the art can clearly understand that the embodiments can be implemented by means of software plus necessary general hardware platforms. Based on such understanding, the above technical solutions, in essence, or the parts that make contributions to the related art, may be embodied in the form of a software product, and the computer software product may be stored in a computer-readable storage medium, such as ROM/RAM, magnetic disks, optical discs, etc., including several instructions for enabling a computer device (which may be a personal computer, a server, or a network device, etc.) to execute the methods of each embodiment or certain parts of the embodiments. Relational terms such as first and second herein are only used to distinguish one entity or operation from another entity or operation, and do not necessarily require or imply that there is any such actual relationship or order between these entities or operations. Moreover, the terms “include”, “including”, or any other variants thereof are intended to cover non-exclusive inclusion, such that a process, method, article, or device including a series of elements not only includes those elements, but also includes other elements not explicitly listed, or also includes elements inherent to such a process, method, article, or device. Without further limitation, an element defined by the statement “including one . . . ” does not exclude the presence of additional identical elements in the process, method, article, or device that includes the elements.

The above embodiments are provided solely for illustrating the technical solutions of the present disclosure, and are not intended to limit the scope of the present disclosure. Although the present disclosure has been described in detail with reference to the foregoing embodiments, it should be understood by those of ordinary skill in the art that they may still make modifications to the technical solutions described in the foregoing embodiments, or make equivalent substitutions for some of the technical features thereof. Such modifications or substitutions made without departing from the spirit and scope of the present disclosure shall fall within the scope of the disclosure defined by the appended claims.

What is claimed is:

1. A method for analyzing post-assembly residual stresses in a microwave assembly, the microwave assembly comprising a housing, a low temperature co-fired ceramics (LTCC) substrate, a connector, partition ribs, a carrier module, a plurality of components, and a cover plate, the carrier module and the plurality of components being assembled on the LTCC substrate, the carrier module comprising a carrier and a power chip assembled on the carrier, the LTCC substrate being assembled in the housing, the connector being assembled on the housing, and the partition ribs being assembled on the LTCC substrate for forming of microwave channels that are mutually isolated with one another, and the method comprising:
obtaining a three-dimensional model of the entire microwave assembly and a three-dimensional model of a tooling required for each high-temperature treatment process based on each high-temperature treatment process involved in an assembly process of the microwave assembly;
obtaining a finite element mesh model of the entire microwave assembly based on the three-dimensional model of the entire microwave assembly;
obtaining a finite element mesh model of the tooling required for each high-temperature treatment process based on the three-dimensional model of the tooling required for each high-temperature treatment process;
performing simulation analysis on each high-temperature treatment process based on the finite element mesh model to obtain a residual stress distribution of each high-temperature treatment process; and
superimposing the residual stress distribution of each high-temperature treatment process to obtain a post-assembly residual stress distribution.

2. The method according to claim 1, wherein the assembly process of the microwave assembly comprises:
soldering the power chip to the carrier using gold-tin solder via hot-plate soldering to obtain the carrier module;
bonding part of the plurality of components to the LTCC substrate via adhesive bonding;
soldering the carrier module, the rest of the plurality of components, and the partition ribs to the LTCC substrate using SAC305 solder via reflow soldering;
soldering the LTCC substrate and the connector to the housing using tin-lead solder via low-temperature vacuum brazing; and
welding the housing with the cover plate via laser welding.

3. The method according to claim 2, wherein performing the simulation analysis on each high-temperature treatment process based on the finite element mesh model to obtain the residual stress distribution of each high-temperature treatment process comprises:
performing thermal simulation based on a thermal analysis model of each high-temperature treatment process, to obtain a temperature distribution when a temperature control curve decreases to a solder melting point; and
performing mechanical simulation based on a mechanical analysis model of each high-temperature treatment process and the temperature distribution, to obtain a residual stress distribution σ when the microwave assembly is cooled to room temperature.

4. The method according to claim 3, wherein performing the thermal simulation based on the thermal analysis model of each high-temperature treatment process, to obtain the temperature distribution when the temperature control curve decreases to the solder melting point comprises:
performing transient thermal analysis using finite element analysis software based on the finite element mesh model corresponding to each high-temperature treatment process, to obtain a pre-calibration temperature distribution when the temperature control curve decreases to the solder melting point;
obtaining a calibration result of a key thermal parameter corresponding to each high-temperature treatment process, based on the pre-calibration temperature distribution when the temperature control curve decreases to the solder melting point; and
performing transient thermal analysis again using the finite element analysis software based on the calibration result of the key thermal parameter, to obtain a post-calibration temperature distribution when the temperature control curve decreases to the solder melting point.

5. The method according to claim 3, wherein:
soldering the power chip to the carrier via hot-plate soldering corresponds to a first high-temperature treatment process; and in the first high-temperature treatment process, the key thermal parameter is an interfacial thermal resistance Rᵢₘₚ between a hot plate and an assembly;
for the first high-temperature treatment process, the thermal simulation comprises:
importing a finite element mesh model of the power chip and the carrier that are assembled via hot-plate soldering and a finite element mesh model of a corresponding tooling into a finite element analysis software Abaqus®; during software setup, setting the hot plate as a heat source, setting a temperature of the heat source as a hot-plate temperature control curve, and determining an empirical value of the interfacial thermal resistance between the hot plate and the assembly;
performing transient thermal analysis using the finite element analysis software, to obtain a temperature distribution of the microwave assembly when the hot-plate temperature control curve decreases to a gold-tin solder melting point of 280° C.;
calibrating the interfacial thermal resistance between the hot plate and the assembly to obtain a corrected empirical value R′ᵢₘₚ of the interfacial thermal resistance between the hot plate and the assembly; and
performing transient thermal analysis again based on the corrected empirical value
$${R}_{imp}^{′}$$
of the interfacial thermal resistance between the hot plate and the assembly, to obtain a corrected temperature distribution of the microwave assembly when the hot-plate temperature control curve decreases to the solder melting point.

6. The method according to claim 5, wherein calibrating the interfacial thermal resistance between the hot plate and the assembly satisfies the following expressions:
$$Min f ( α ) = \sum {( α {T}_{K} - {t}_{K} )}^{2} ; and {R}_{imp}^{′} = α * {R}_{imp}$$
wherein α represents a correction coefficient when f(α) is minimum, and α is obtained by calculation;
wherein T_{K} represents a simulated temperature value at a K-th detection point, and T_{K} is obtained by simulation software;
wherein t_{K} represents a detected temperature value at the K-th detection point, and t_{K} is obtained by a temperature sensor placed on a surface of a test piece or at a test hole within the test piece;
wherein Rᵢₘₚ represents the empirical value of the interfacial thermal resistance between the hot plate and the assembly; and
wherein
$${R}_{imp}^{′}$$
represents the correct empirical value of the interfacial thermal resistance between the hot plate and the assembly.

7. The method according to claim 3, wherein:
soldering the carrier module, the rest of the plurality of components, and the partition ribs to the LTCC substrate via reflow soldering corresponds to a second high-temperature treatment process; and in the second high-temperature treatment process, the key thermal parameter is a convective heat transfer coefficient h; and
for the second high-temperature treatment process, the thermal simulation comprises:
importing finite element mesh models corresponding to the carrier module, the rest of the plurality of components, the partition ribs, the LTCC substrate, and a corresponding tooling into a finite element analysis software Abaqus®; setting surfaces of the assembly and the tooling in contact with hot air as convective heat transfer surfaces, determining an empirical value of the convective heat transfer coefficient, and setting a hot-air temperature as a furnace temperature control curve;
performing transient thermal analysis using the finite element analysis software, to obtain a temperature distribution of the microwave assembly when the furnace temperature control curve decreases to a SAC305 solder melting point of 218° C.;
calibrating the convective heat transfer coefficient by placing five temperature sensors on a surface of the assembly or a surface of the tooling, to obtain a corrected convective heat transfer coefficient h′; and
performing transient thermal analysis again based on the corrected convective heat transfer coefficient h′, to obtain a corrected temperature distribution of the microwave assembly when the furnace temperature control curve decreases to the solder melting point.

8. The method according to claim 7, wherein calibrating the convective heat transfer coefficient satisfies the following expressions:
$$Min f ( α ) = \sum {( α {T}_{K} - {t}_{K} )}^{2} ; and {h}^{′} = α * h$$
wherein α represents a correction coefficient when f(α) is minimum, and α is obtained by calculation;
wherein T_{K} represents a simulated temperature value at a K-th detection point, and T_{K} is obtained by simulation software;
wherein t_{K} represents a detected temperature value at the K-th detection point, and t_{K} is obtained by a temperature sensor;
wherein h represents an empirical value of the convective heat transfer coefficient; and
wherein h′ represents the corrected convective heat transfer coefficient.

9. The method according to claim 3, wherein soldering the LTCC substrate and the connector to the housing via low-temperature vacuum brazing corresponds to a third high-temperature treatment process; and in the third high-temperature treatment process, the key thermal parameter is a surface emissivity; and
for the third high-temperature treatment process, the thermal simulation comprises:
importing an .inp file of a corresponding finite element mesh model into Abaqus®, setting a heating wire in a furnace as a radiation heat source, determining an empirical value of a surface emissivity of the assembly and the tooling, and setting a temperature of the radiation heat source as a furnace temperature control curve;
performing transient thermal analysis using the finite element analysis software, to obtain a temperature distribution of the microwave assembly when the furnace temperature control curve decreases to the solder melting point;
calibrating the surface emissivity ε of the assembly and the tooling by placing three temperature sensors on a surface of the assembly to obtain a corrected surface emissivity ε′; and
performing transient thermal analysis again based on the corrected surface emissivity ε′, to obtain a corrected temperature distribution of the microwave assembly when the furnace temperature control curve decreases to the solder melting point.

10. The method according to claim 9, wherein calibrating the surface emissivity ε of the assembly and the tooling satisfies the following expressions:
$$Min f ( α ) = \sum {( α {T}_{K} - {t}_{K} )}^{2} ; and {ε}^{′} = α * ε$$
wherein α represents a correction coefficient when f(α) is minimum, and α is obtained by calculation;
T_{K} represents a simulated temperature value at a K-th detection point, and T_{K} is obtained by simulation software;
t_{K} represents a detected temperature value at the K-th detection point, and t_{K} is obtained by a temperature sensor;
ε represents an empirical value of the surface emissivity; and
ε′ represents the corrected surface emissivity.
